(19) United States
(12) Patent Application Publication
(10) Pub. No.: US 2017/0144605 A1
(43) Pub. Date: May 25, 2017

(54) STOWABLE LADDER SYSTEM

(71) Applicant: Kelly Industries, LLC, South Jordan, UT (US)

(72) Inventors: James E. Kelly, South Jordan, UT (US); Christopher J. Knapp, Murray, UT (US); Donald G. Gansen, West Jordan, UT (US); Timothy R. Nieman, North Salt Lake, UT (US); Joshua C. Lund, Midvale, UT (US)

(73) Assignee: Kelly Industries, LLC, South Jordan, UT (US)

(21) Appl. No.: 15/053,079

(22) Filed: Feb. 25, 2016

Related U.S. Application Data
(63) Continuation-in-part of application No. 14/948,533, filed on Nov. 23, 2015.

(51) Int. Cl. B60R 3/02; E06C 5/04

(52) U.S. Cl. CPC B60R 3/02; E06C 5/04

(57) ABSTRACT

The embodiment enclosed relates to systems and methods for aiding a user in accessing the roof of a vehicle. The user may be accessing items stored on the roof, cleaning the roof, or otherwise performing some desired action relating to the roof/upper exterior area of a vehicle. The user may additionally be attempting to reach other elevated areas of the vehicle. The embodiment may include a ladder which may attach to a roof rack system attached to a vehicle. The roof rack system may be installed by the manufacturer or may be a third party, aftermarket system. The ladder system may easily detach and attach to the roof rack system and may enable a user to access various elevated portions of the vehicle. The ladder may store in proximity to the roof when not in use and therefore may enable a user to easily access the ladder when desired. In some embodiments, the ladder may additionally and/or alternatively be stored proximate the vehicle to enable access to elevated areas of the vehicle.

### CROSS-REFERENCE TO RELATED APPLICATIONS

This application in a continuation in part of U.S. patent application Ser. No. 14/948,533 filed Nov. 23, 2015, currently pending, titled “Stowable Ladder System.”

### BACKGROUND

Vehicles are used to transport cargo every day. Vehicles transport everything from sporting equipment to groceries to vacation items. To aid in the transport of items, vehicle users may opt to purchase roof racks with the vehicle and/or have an aftermarket roof rack system installed on the vehicle. The roof rack system may enable the transport of a plethora of items.

A vehicle may have a transportation cargo pod installed as part of the roof rack system. The transportation cargo pod may provide additional storage space to the vehicle user. The roof rack system may enable transportation of bicycles, snow equipment, water equipment, etc. However, the roof rack system may be difficult to access. A height differential between the user and the vehicle may make the roof rack system unmanageable. A user may have to climb onto/into the vehicle to reach the roof. This may result in the user opening a passenger and/or driver door and stepping on the seat of the vehicle and/or potentially damaging the seat and/or the side of the vehicle and/or the exterior. If the weather is cold or hot, climbing on the seats may allow exterior air to enter a vehicle causing discomfort to passengers. In inclement weather, this may damage the interior of the car. Utilization of a step ladder is safe only on stable ground, which is unlikely to be available in many situations where roof rack use occurs.

### SUMMARY

The embodiment enclosed relates to systems and methods for aiding a user in accessing the roof of a vehicle. The user may be accessing items stored on the roof, cleaning the roof, or otherwise performing some desired action relating to the roof/upper exterior area of a vehicle. The user may additionally be attempting to reach other elevated areas of the vehicle. The embodiment may include a ladder which may attach to a roof rack system attached to a vehicle. The roof rack system may be installed by the manufacturer or may be a third party, aftermarket system. The ladder system may easily detach and attach to the roof rack system and may enable a user to access various elevated portions of the vehicle. The ladder may store in proximity to the roof when not in use and therefore may enable a user to easily access the ladder when desired. In some embodiments, the ladder may additionally and/or alternatively be stored proximate the vehicle to enable access to elevated areas of the vehicle.

In one embodiment, an apparatus for accessing an elevated area of a vehicle is described. The apparatus may comprise a first brace beam configured to be coupled to the vehicle and a second brace beam spaced from the first brace beam and configured to be coupled to the vehicle. The apparatus may include a ladder pivotally coupled to the first and second brace beams which may be movable between a stored position and a deployed position. In some embodiments, the first and second brace beam are coupled to a rack system proximate the vehicle. In other embodiments, the vehicle is a trailer. In some instances, the ladder may be an adjustable length ladder comprising a plurality of sections. In other instances, the ladder may be a folding ladder comprising a plurality of sections. The sections may be secured to maintain a length of the ladder when a locking mechanism proximate the ladder is engaged. In some embodiments, a total number of the plurality of sections may determine a length of the ladder when the ladder is fully expanded.

In some instances, a first slidable member may be movably coupled to the first brace beam and a second slidable member may be movably coupled to the second brace beam. The ladder may be pivotally coupled to the first slidable member and pivotally coupled to the second slidable member. The first and second slidable members may move in line with the first and second brace beam. In some instances, the ladder may be movable between a first position in which the ladder is stored on the elevated area of the vehicle, and a second position in which the ladder is accessible for a user to access the elevated area of the vehicle.

In another embodiment, an apparatus for accessing an elevated area of a vehicle is described. The apparatus may comprise a first brace beam configured to be coupled to the vehicle and a second brace beam configured to be coupled to the vehicle. The apparatus may include a first slidable member movably coupled to the first brace beam and a second slidable member movably coupled to the second brace beam. The apparatus may additionally include a ladder pivotally coupled to the first and second slidable members. The length of the ladder may be fixed. The ladder may comprise a plurality of adjustable sections. The ladder may be movable between a stored position and a deployed position.

In some embodiments, the apparatus may include a first cross-beam and a second cross-beam. The second cross-beam may be spaced laterally from the first cross-beam. In some embodiments, the first brace beam may have a first end and a second end arranged opposite the first end. The first end being may be coupled to the first cross-beam and the second end may be coupled to the second cross-beam. In some instances, the second brace beam may have a first end and a second end arranged opposite the first end. The first end may be coupled to the first cross-beam and the second end may be coupled to the second cross-beam.

In some embodiments, the first brace beam may be moveably coupled to the first and second cross-beam and the second brace beam may be moveably coupled to the first and second cross-beam. In other embodiments, the first brace beam may be rigidly coupled to the first and second cross-beam and the second brace beam may be rigidly coupled to the first and second cross-beam.

In some embodiments, the adjustable sections of the ladder may determine a total length of the ladder. The sections may secure a length of the ladder when a locking mechanism is engaged. In some embodiments, the apparatus may include an axle with a first end and a second. The first end may be rotatably coupled to the first slidable member and the second end may be rotatably coupled to the second slidable member. In some embodiments, the ladder may be pivotable between a first position in which the ladder is stored on the elevated area of the vehicle and a second position in which the ladder is accessible for a user to access the elevated area from a first side of the vehicle. The ladder may be slidable between the first position and the second position.

In some embodiments, the first slidable member may be rotatably coupled to the first brace beam, and the second slidable member may be rotatably coupled to the second brace beam. The ladder may be pivotable into a third position in which the ladders is accessible for a user to access the elevated area from a second side of the vehicle, the ladder being pivotable between the second and third positions upon rotation of the first and second slidable members relative to the first and second brace beams, respectively.

In some embodiments, a support member may connect the first brace beam and the second brace beam. The ladder may rest upon the support member in the first position. In some embodiments, a bushing may be positioned between the first slidable member and the first cross-beam when the ladder is arranged to permit a user to access the elevated area of the vehicle. The ladder may deforms the bushing between the first slidable member and the first cross-beam upon application of a downward force on the ladder.

In some embodiments, the first and second brace beams may be arranged substantially perpendicular to the first and second cross-beams, and the first and second brace beams may slidably traverse the first and second cross-beams upon application of a force to the first and second brace beams. In some embodiments, a first mounting mechanism may be configured to couple the first brace beam to a vehicle cargo apparatus system and a second mounting mechanism may be configured to couple the second cross-beam to the vehicle cargo apparatus system.

In another embodiment, a method for accessing an elevated area of a vehicle is described. The method may comprise providing an adjustable vehicle ladder and sliding the ladder from a rest position proximate the vehicle to a protruding position at a first side of the vehicle. The method may include pivoting the ladder from the protruding position to an operational position adjacent to the first side of the vehicle. The method may include extending a length of the ladder to an engaged length contacting a support surface upon which the vehicle is supported. The ladder may be movable between a stored position and a deployed position.

In some embodiments, the method may include unsecuring the ladder from the rest position and fastening the ladder in the operational position. In some embodiments, the method may include securing the ladder in the engaged length. In some embodiments, the method may include pivoting the ladder from the first side of the vehicle to a second side of the vehicle.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the spirit and scope of the appended claims. Features which are believed to be characteristic of the concepts disclosed herein, both as to their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the embodiments may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is an isometric view of an exemplary vehicle with a roof rack sy stem;

FIG. 2 is a side view of a vehicle with an exemplary ladder system;

FIG. 3 is a front view of a vehicle with an exemplary ladder system;

FIG. 4 is a front view of a vehicle with an exemplary ladder system;

FIG. 5 is an isometric view of an exemplary ladder system;

FIG. 6 is an isometric view of an exemplary ladder system;

FIG. 7A is a top down view of an exemplary attachment system;

FIG. 7B is a cut-away view of an exemplary locking system in a load beam;

FIG. 8A is a top down view of an exemplary attachment system;

FIG. 8B is a cut-away view of an exemplary locking system in a load beam;

FIG. 9 is a side view of a vehicle with an exemplary ladder system having a ladder in a deployed position;

FIG. 10 is a front view of the vehicle and ladder system shown in FIG. 9 with the ladder in the deployed position;

FIG. 11 is a front view of the vehicle and ladder system shown in FIG. 9 with the ladder in a stowed position;

FIG. 12 is an isometric view of an exemplary ladder system with a ladder in a deployed position;

FIG. 13 is an isometric view of the ladder system shown in FIG. 12 with the ladder in a stowed position; and

FIG. 14 is an exemplary flow chart relating to operation of an exemplary ladder system.

While the embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION

The systems and methods described herein may, at least in part, relate to vehicles and roof rack systems. For the purposes of this disclosure, the term “aligned” means parallel, substantially parallel, or forming an angle of less than 35.0 degrees. Also, for the purposes of this disclosure, the term “transverse” means perpendicular, substantially perpendicular, or forming an angle between 55.0 and 125.0 degrees. Further, for purposes of this disclosure, the term “length” refers to the longest dimension of an object.

In some embodiments, vehicles are equipped with roof rack systems. The roof rack systems may be purchased by a third party provider and attached to the vehicle. A roof rack system may have at least two load beams. The loads beams may be hollow elongated members with a cap on opposing ends. The caps may be removable. To allow a person to access the roof, a collapsible ladder may be attached to an end of the load beams. The ladder may store easily on the roof but may be movable to allow a user to extend down the side of vehicle. The ladder may not touch the vehicle thus preventing possible damage such as scratching of the vehicle.

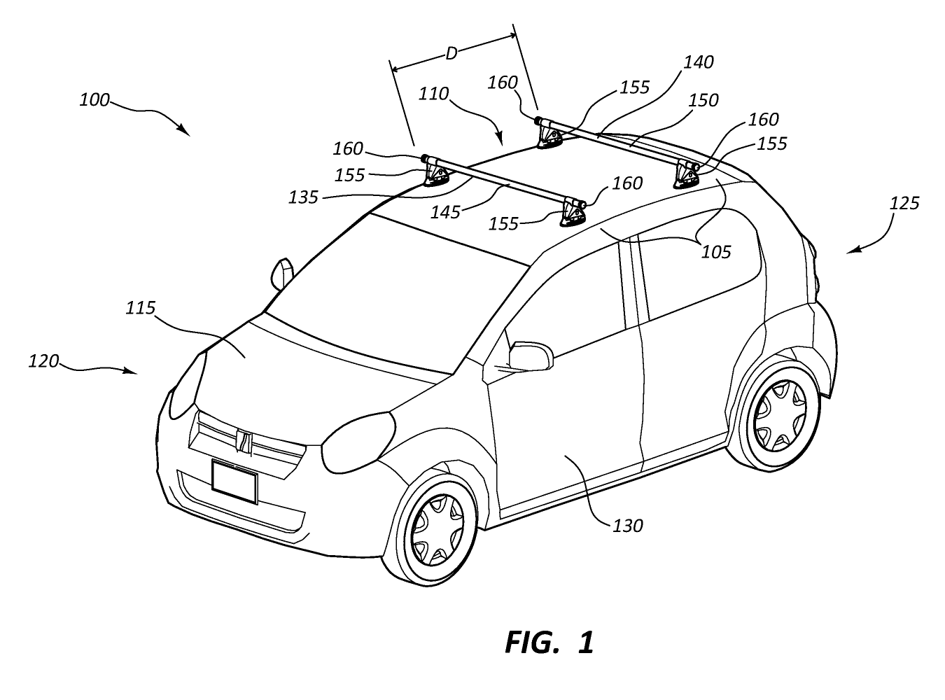

FIG. 1 is an isometric view of a vehicle 100 with a roof rack system 105 installed proximate the roof 110 of the vehicle. The vehicle 100 may comprise a standard size vehicle such as a coupe, sedan, wagon, hatchback, or the like. The vehicle 100 may also comprise a standard utility vehicle (SUV), crossover, truck, minivan, or the like. The vehicle 100 shown in FIG. 1 is merely representative of a generic vehicle and is not meant to limit the disclosure herein.

The vehicle 100 may include a body 115 of the vehicle 100 with a forward end 120 and a rear end 125 opposite the forward end 120. The vehicle 100 may include one or more doors 130. The roof 110 of the vehicle 100 may have a roof rack system 105 installed. In the embodiment shown, the roof rack system 105 may comprise a forward roof rack 135 and a rear roof rack 140. However, the roof rack system 105 may comprise additional racks as suitable. The forward and rear roof racks 135, 140 may comprise a load beam 145, 150 each with at least two attachment means 155 to the vehicle 100. The load beams 145, 150 may be substantially hollow and may include end caps 160 on the ends of the load beams 145, 150. The end caps 170 may be removable. The distance D between the roof racks 135, 140 may vary depending on the make and model of the vehicle 100 and number of roof racks installed.

The roof rack system 105 may allow the storage of cargo for transportation. The vehicle 100 may be equipped with an enclosed cargo box, snow equipment transportation, bicycle transportation, canoes, kayaks, and the like. However, accessing the roof 110 of the vehicle 100 can be difficult. The height difference between a person and the roof 110 may require a person to climb on the vehicle 100 to access the roof 110. Alternatively, a step stool or ladder may be used but the step stool or ladder may require transportation. The step stool or ladder may need to fit inside the vehicle 100. There may not be enough room in the vehicle 100 or the step stool or ladder may be dirty. Further, the ground on which an unsecured step ladder might rest could be fouled with snow, ice, mud, rocks, etc., making security of the ladder uncertain.

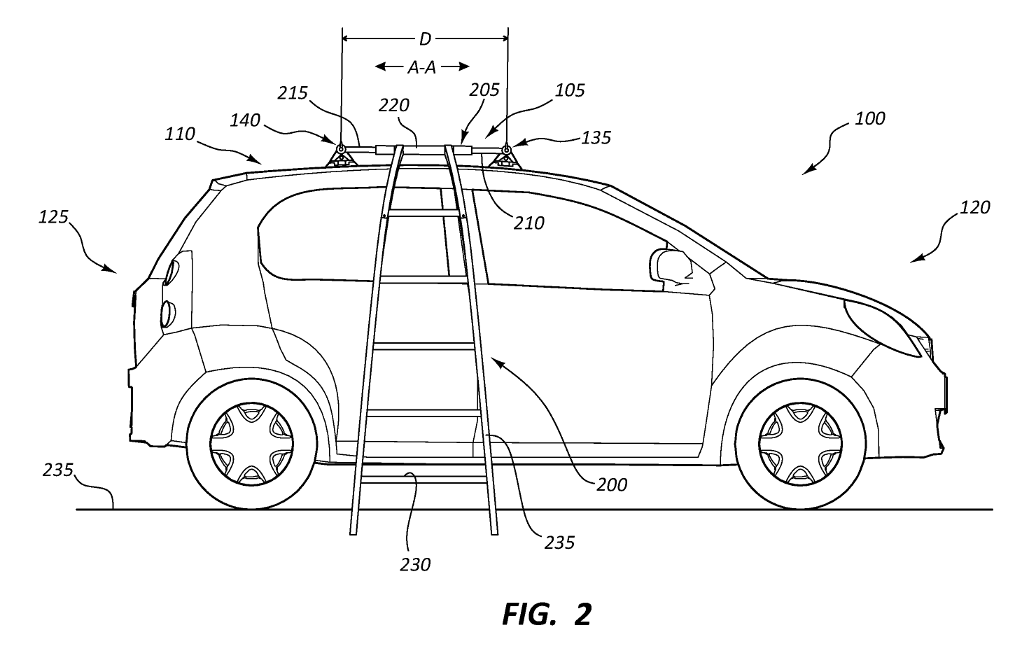

FIG. 2 is a side view of a vehicle 100 with a roof rack system 105 and ladder system 200 installed proximate the roof 110 of the vehicle. The ladder system 200 may enable a person to easily access the roof 110 of the vehicle 100. The ladder system 200 may include a cross-beam system 205 with a ladder 225 attached thereto. The ladder system 200 may attach to the roof rack system 105 and be mobile with the vehicle 100. The ladder system 200 may additionally be installed on other types of vehicles including a pop-up camper, a trailer, or any other item that may have a roof rack system 105 attached to it.

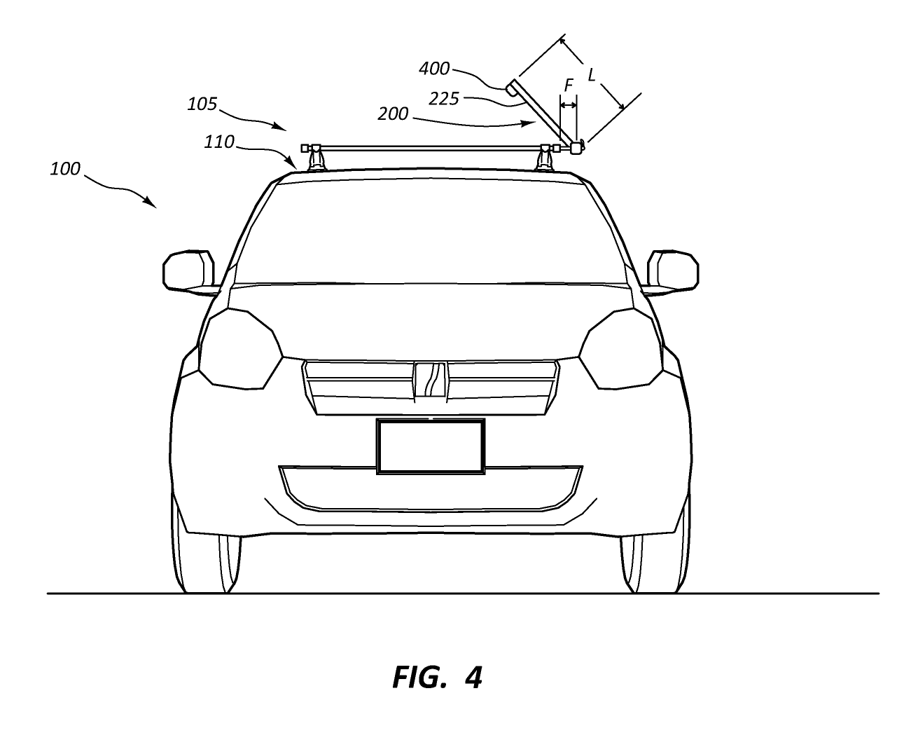

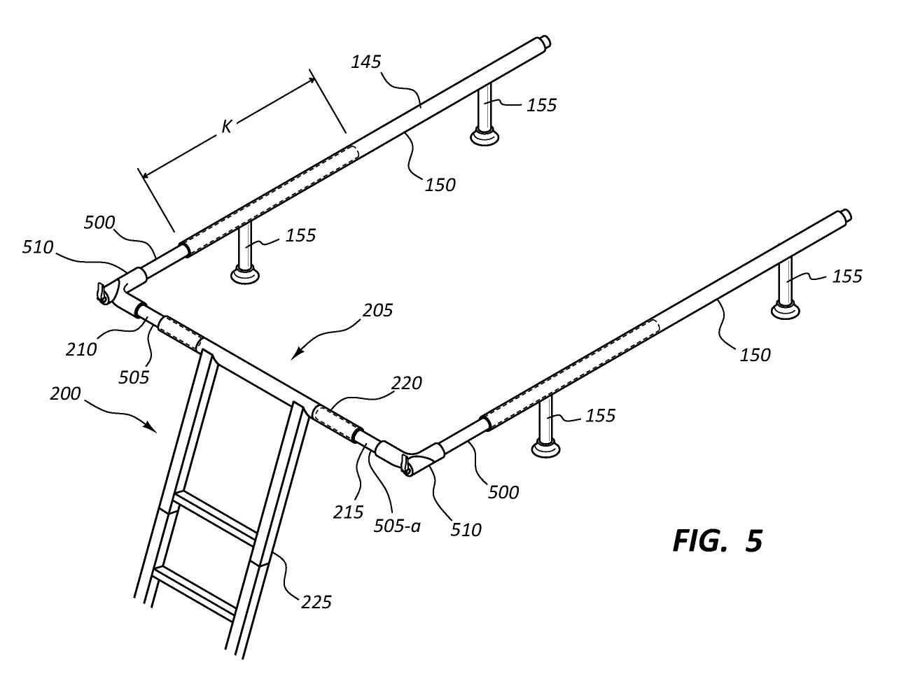

The cross-beam system 205, shown in greater detail in FIG. 5, may connect to the first roof rack 135 and the second roof rack 140 via one or more attachment means 210, 215 and may include a rotatable member 220 coupled to the collapsible ladder 225. The rotatable member 220 may enable the ladder 225 to rotate from a stored position (discussed with reference to FIG. 4) or an engaged position as shown in FIG. 2. The rotatable member 220 may also slide laterally between the attachments 210, 215 as indicated by arrows A-A. This may enable a user to easily access a more forward 120 or aft 125 part of the vehicle 100. As will be explained with greater detail below, the cross-beam system 205 may structurally connect the first roof rack 135 and the second roof rack 140. However, the distance D between the first roof rack 135 and the second roof rack 140 may not be equivalent for all make and model vehicles. Different vehicles may have different distances D between the two roof racks 135, 140. The cross-beam system 205 may have the ability to extend between the different distances D that may be present.

The ladder 225 is shown in an engaged position wherein the ladder 225 is accessible to climb and extends to, and rests upon, the ground 235. The ladder 225 may enable a person to climb up rungs 230 to a desired height to reach cargo that may be stored atop the roof 110. The rungs 230 may allow a person to load cargo or remove cargo from the roof 110, to clean the roof, or otherwise provide an added height to enable a person to perform a desired function.

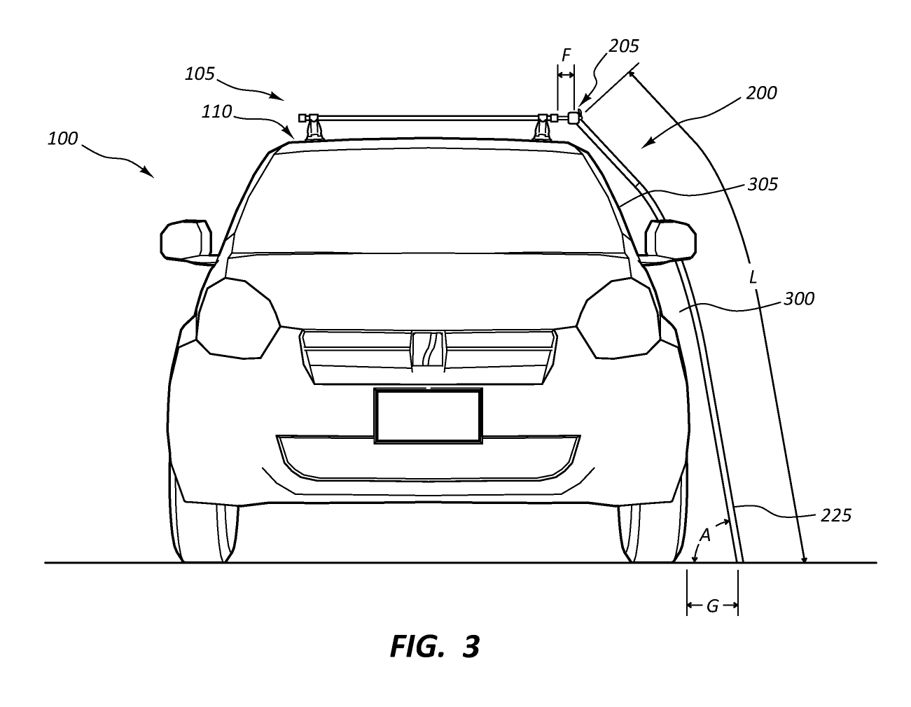

FIG. 3 shows a front view of a vehicle 100 with a roof rack system 105 and ladder system 200 installed proximate the roof 110 of the vehicle. FIG. 3 shows a gap 300 between the ladder 225 and the vehicle 100 wherein the ladder 225 is substantially aligned with a side 305 of the vehicle 100. The gap 300 may prevent the ladder 225 from scratching or otherwise damaging the sides 305 of the vehicle 100. The gap 300 may also enable a user to place their foot on the rung (e.g. rung 230, FIG. 2) of the ladder 225 to which may provide a sturdier climbing surface for the user.

The ladder 225 may have two adjustable distances which may affect the gap 300 between the vehicle 100 and the ladder 225. The first adjustable distance may be distance F. Distance F may be the distance the cross-beam system 205 is engaged with the roof rack system 105. The distance F may be negligible, or essentially zero. The distance F may also be expanded to create a more vertical angle A between the ground and the ladder 225. The vertical angle A may be a factor of the distance F and the distance G. If distance G remains constant, the vertical angle A will begin to reach ninety (90) degrees as the distance F is increased. Conversely, if the distance F is constant but the distance G is reduced, the vertical angle A will tend towards zero (0) degrees as the angle A is reduced. The ability to adjust the angle A of the ladder 225 may affect the sturdiness of the ladder 225. Adjusting the angle A may also adjust the gap 300 between the ladder 225 and the vehicle 100. In some instances, the distance G may be limited due to space surrounding the vehicle 100. For example, in a parking lot, a second vehicle may restrict movement on the side of the vehicle 100. Adjusting the distances F, G may also allow a person to safely engage the ladder 225, find sturdy ground, or comfortably adjust the ladder 225.

The ladder 225 as shown in FIG. 3 has a slight curvature side profile. The curvature profile may provide a more consistent gap 300 between the ladder 225 and the vehicle 100. While a slight curvature is shown, the curvature may vary from non-existent (i.e. a straight ladder) to a more curved side profile. In some embodiments, the curvature side profile may substantially align with the curvature of the side 300 of the vehicle 100.

The extended length L of the ladder 225 may also be adjustable depending on the vehicle on which the ladder 225 is attached and the ladder 225 itself. For example, the collapsible ladder 225 may be an adjustable length ladder which may have a completely variable length that is fully customizable. The ladder 225 may be a telescoping ladder. The ladder 225 may additionally fold onto itself and may have varying lengths. If the ladder 225 is a foldable ladder, the distances F and G may provide the necessary adjustments for a sturdy ladder 225.

FIG. 4 is a front view of the vehicle 100 with a roof rack system 105 and ladder system 200 installed proximate the roof 110 of the vehicle. The ladder 225 is showed in a collapsed, stored position. The collapsed, stored position of the ladder 225 may allow a user of the automobile to easily transport the ladder with the vehicle 100.

To store the ladder 225, the length L of the ladder 225 may need to be reduced. As mentioned, the ladder 225 may fold onto itself to reduce its length L or it may telescope into itself to a reduced length L. For example, portions of the ladder 225 may store inside other portions of the ladder 225 such that the design is a telescoping design. The ladder 225 may lock in an extended position and in a telescoped position. Alternatively, the ladder 225 may fold out to extend its length L. The length L of the ladder 225 during storage should be small enough to easily store on the roof 110 of the vehicle 100. The storage length L of the ladder 225 may be approximately 10-20 percent of the extended length of the ladder 225. The length L of the ladder 225 may vary depending on vehicle make and model. For example, a larger vehicle may require a longer length L of the ladder 225 whereas a smaller vehicle may not have the need for same length and therefore may have a shorter length L.

As mentioned previously, the ladder 225 may be rotatably coupled to the cross-beam system (e.g. cross-beam system 205, FIG. 2). For example, the ladder 225 may be coupled to the rotatable member (e.g. rotatable member 220, FIG. 2) which may rotate about a portion of the cross-beam system. The rotatable member may enable the ladder 225 to move from an engaged position as shown in FIG. 3 to a stored position as shown in FIG. 4. The ladder 225 may lock in the stored position which may be approximately forty-five (45) degrees from the roof 110 of the vehicle 100. The stored position may also be any angle that may enable the ladder 225 to be stored away from the one or more sides 305 of the vehicle 100. The varying degree of locking angle may enable the ladder 225 to accommodate various sizes and locations of cargo which may be stored proximate the roof 110 of the vehicle 100. For example, snow equipment such as skis or a snowboard may enable the ladder 225 to be stored at a very small angle relative to the roof 110, such as ten to twenty (10-20) degrees. In contrast, a bicycle or canoe may cause the ladder 225 to be stored more in a forty-five (45) degree angle. If no cargo is proximate the roof 110, the ladder 225 may rest directly on the roof 110. This may be beneficial if the vehicle 100 is stopped. However, if the vehicle 100 is moving the ladder 225 may vibrate and bounce on the roof 110 causing undesirable noises to occupants of the vehicle 100. Therefore, the ladder 225 should lock in place when the vehicle 100 is in motion to prevent this type of noise. Alternatively, the ladder 225 may incorporate a footing, bushing, washer, flange or the like to prevent the ladder 225 from contacting the roof 110 of the vehicle 100.

A spring-loaded collar (not shown) on the first or second attachment system (e.g. first or second attachment system 210, 215, FIGS. 1, 5, 6) may mate with complimentary teeth proximate the rotatable member (e.g. rotatable member 220, FIGS. 2, 5, 6). The collar may be fixedly retractable to allow for hands-free positioning. Once in position, the collar may be deployable to mate with the teeth in the rotatable member. This may lock the ladder in an engaged or stored position.

Further, in a stored configuration, the ladder 225 may rest on a cushioning surface 400 attached to the ladder 225 which may minimize potential stress to the collar device and which may protect the roof 110 of the vehicle 100. The cushioning surface 400 may be a semi-compressible material which may rest on the roof 110 of the vehicle 100 if the ladder 225 is stored on top of the roof 110. The cushioning surface 400 may comprise a weather-resistant material such as a polymer.

FIG. 5 is a close-up view of the cross-beam system 205 and the load beams 145, 150 of the roof rack system 105. The cross-beam system 205 as shown may include a portion of the ladder 225 and elements of the cross-beam system 205. The first load beam 145 may be either the forward or aft roof rack such that the ladder 225 may be mounted on either the driver or passenger side of the vehicle 100. In some embodiments, a single vehicle may additionally be fitted with a ladder system on both the driver and passenger side of the vehicle 100.

The cross-beam system 205 may comprise a first attachment 210, a second attachment 215, and a rotatable member 220. The first and second attachment may attach the ladder system 200 to the roof rack system 105. The first and second attachment 210, 215 may be complimentary and/or may be symmetrical. The first attachment 210 may comprise an insertion beam 500, an extension beam 505, and a corner joint 510 connecting the insertion beam 500 and the extension beam 505 together. The insertion beam 500 and extension beam 505 may be substantially transverse to each other.

The insertion beam 500 may insert into a hollow portion of the load beam 145. For example, the insertion beam 500 may have an outer diameter which may be less than an inner diameter of the load beam 145. This may allow a user to easily slide the insertion beam 500 into the hollow portion of the load beam 145. The insertion beam 500 may insert into the load beam 145 enough to provide structural support to the overall ladder system 200. The insertion beam 500 may insert at least twenty percent (20%) into the load beam 145. In some embodiments, the insertion beam 500 may insert a greater percentage into the load beam 145. The insertion length may vary depending on make and model of the vehicle as well as number of ladder systems installed.

The extension beam 505 may extend from the corner joint 510 towards the opposing load beam 150. In some embodiments, the extension beam 505 may be a single piece connecting to the corner joint 510 of the second attachment 215. In another embodiment as shown in FIG. 5, each extension beam 505 may extend only a portion of the distance between the two joints 510 such that there is a gap between a first extension beam 505 and a second extension beam 505-a.

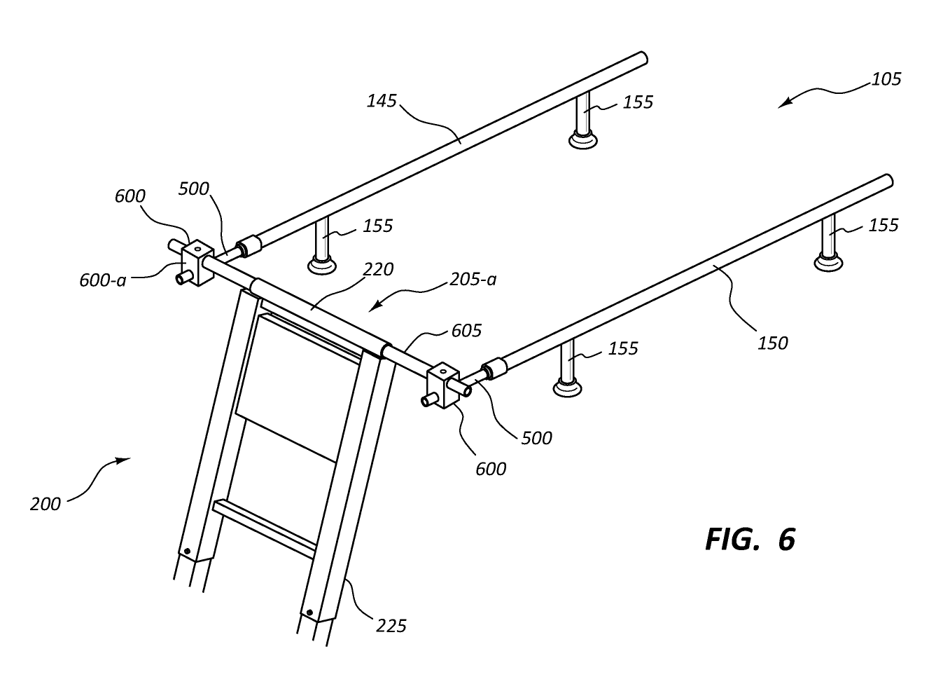

FIG. 6 is a close-up view of another embodiment of the cross-beam system 205 and the load beams 145, 150 of the roof rack system 105. The cross-beam system 205 as shown may include a portion of the ladder 225 and elements of the cross-beam system 205. The first load beam 145 may be either the forward or aft roof rack such that the ladder 225 may be mounted on either the driver or passenger side of the vehicle 100.

The embodiment shown incorporates a different corner joint 600 with a single piece extension beam 605. The extension beam 605 couples a first corner joint 600 and a second corner joint 600-a. The rotatable member 220 may fit over the single piece extension beam 605. The corner joint 600 also represents a different configuration. The corner joint 600 may be box shaped with through holes that the extension beam 605 and insertion beam 500 may fit into. The through holes and extension beam 605 and insertion beam 500 may be tight fit such that an outer diameter of the extension beam 605 and insertion beam 500 is slightly larger than the inner diameter of the through holes. In another embodiment, the extension beam 605 and insertion beam 500 may be glued, screwed, or otherwise fixed to the corner joint 600.

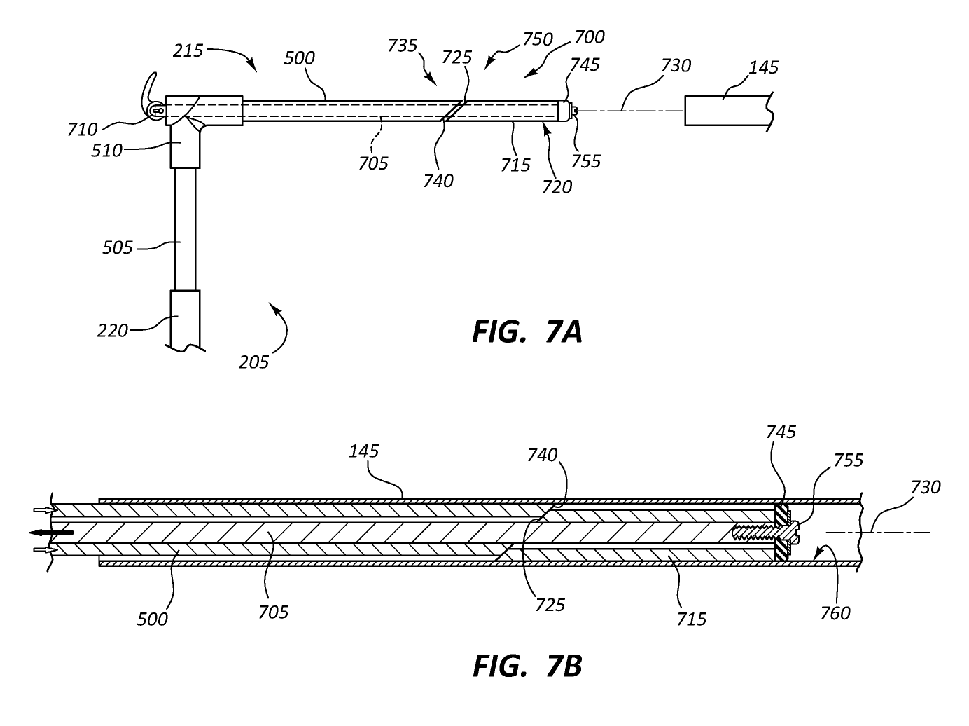

FIG. 7A is a top down view of the first attachment means 215, which is also representative of second attachment means. The first attachment means 215 may include an insertion beam 500, an extension beam 505, and a corner joint 510. The insertion beam 500 may include a locking mechanism 700 which may fasten the insertion beam 500 to a load beam (e.g. load beam, 145, 150).

The locking mechanism 700 may comprise a tightening mechanism 705 with a handle 710 and a compression mechanism 715. The compression mechanism 715 may create a tight fit between the inner diameter of the load beam and the outer diameter 720 of the insertion beam 500. The compression mechanism 715 may be a substantially cylindrical member with a diagonal surface 725 proximate the insertion beam 500. The diagonal surface 725 may be an angle between twenty (20) and seventy (70) degrees from an axis 730 aligned with the cylindrical member 720. An end 735 of the insertion beam 500 may have a complimentary diagonal surface 740 proximate the compression mechanism 715.

The tightening mechanism 705 may be couple to the compression mechanism 715. For example, the tightening mechanism 705 may attach to a washer 745 proximate a flat end of the compression mechanism 715. The tightening mechanism 705 may be a threaded member which may pass through a hole in the washer 740 and attach to a nut 755 on the opposite side of the washer 740. The tightening mechanism 705 may then pass through a hollow portion of the insertion beam 500 and through a hole 750 in the corner joint 510. The tightening mechanism 705 may then attach to the handle 710.

The handle may cause the tightening mechanism 705 to rotate. This may bring the compression mechanism 715 towards the insertion beam 500. Shown in FIG. 7B, as the opposing diagonal surfaces 725, 740 meet, the compression mechanism 715 may push against an inner diameter 755 of the load beam 145. This may cause the insertion beam 500 to lock against load beam 145 which may hold the cross-beam system in place. The handle 710 may enable quick adjustment of distance F. Altering distance F may aid in the use of the ladder as discussed with reference to FIG. 3.

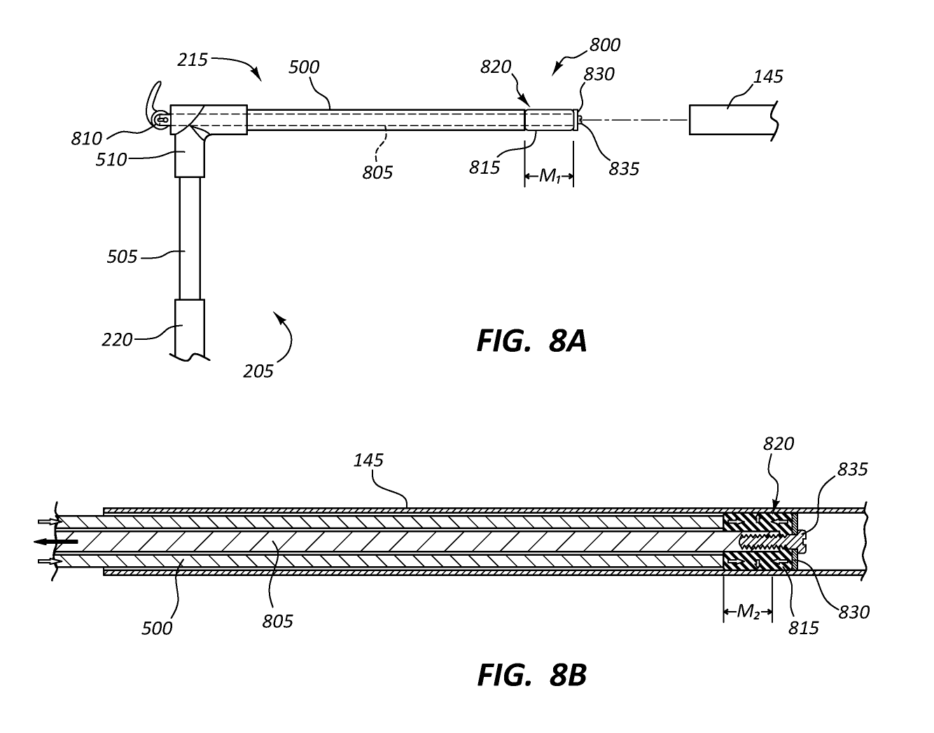

FIG. 8 is a top down view of the first attachment means 215, which is also representative of second attachment means. The first attachment means 215 may include an insertion beam 500, an extension beam 505, and a corner joint 510. The insertion beam 500 may include another embodiment of a locking mechanism 800 which may be coupled to the insertion beam 500 to a load beam (e.g. load beam, 145, 150).

The locking mechanism 800 may comprise a tightening mechanism 805 with a handle 810 and a compression mechanism 815. The compression mechanism 815 may create a tight fit between the inner diameter of the load beam and the outer diameter 820 of the insertion beam 500. The compression mechanism 815 may be a substantially cylindrical member comprising a compressible material. The compression mechanism 815 may have a first diameter when not engaged.

The tightening mechanism 805 may be coupled to the compression mechanism 815. For example, the tightening mechanism 805 may pass through a hole 825 in the compression mechanism and attach to a washer 830. The tightening mechanism 805 may be a threaded member which may pass through a hole in the washer 830 and attach to a nut 835 on the opposite side of the washer 840. The tightening mechanism 805 may then pass through a hollow portion of the insertion beam 500 and through a hole 845 in the corner joint 510. The tightening mechanism 805 may then attach to the handle 810.

The handle 810 may cause the tightening mechanism 805 to rotate. This may cause a length M of the compression mechanism 815 to reduce and may cause the diameter 820 of the compression mechanism 815 to increase. Shown in FIG. 8B, as the compressible material is tightened against the end of the insertion beam 500, the compressible material may expand in diameter. The expansion may create a tight fit between the compression mechanism 815 and an inner diameter of the load beam 145.

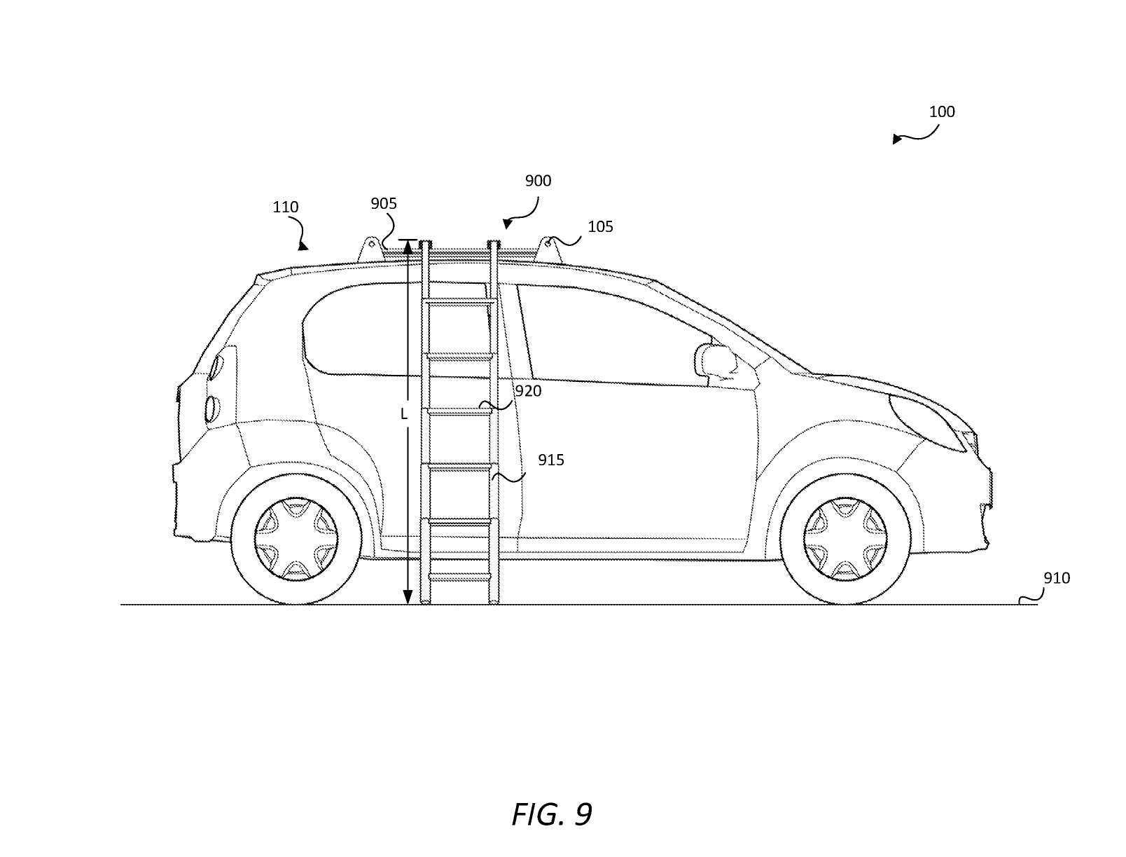

FIG. 9 is a side view of a vehicle 100 with a roof rack system 105 and an alternative ladder system 900 installed proximate the roof 110 of the vehicle 100. The ladder system 900 may include a support system 905 with a ladder 915 attached thereto. The ladder 915 may be similar to the ladder 225 described above. The ladder system 900 may attach to the roof rack system 105 and be mobile with the vehicle 100. The ladder system 900 may enable a person to easily access the roof 110 of the vehicle 100 or other areas difficult to reach from a ground position. The ladder system 900 may additionally and/or alternatively be configured to attach to other aspects of vehicles such as a bed of a pickup truck, or other mounting structures on vehicles such as scaffolding or tool boxes on a truck or utility trailer, etc. The ladder system 900 may additionally be installed on other types of vehicles including a pop-up camper, a trailer, or any other item that may have a roof rack system 105 attached to it.

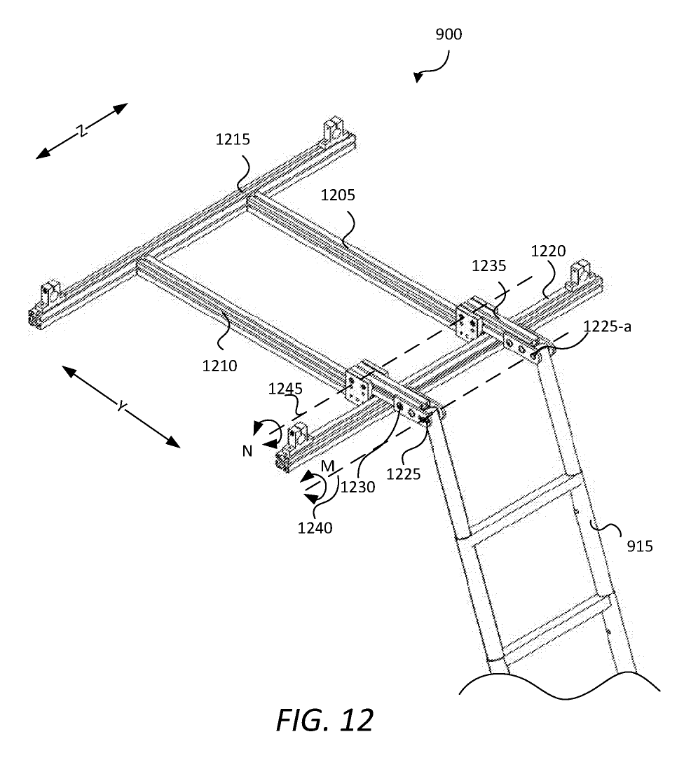

The cross-beam system 905, shown in greater detail in FIG. 12, may connect to the first roof rack 135 and the second roof rack 140 via one or more attachment features. In other embodiments, the cross-beam system 905 may connect to other aspects of a vehicle or utility trailer, such as directly to the roof structure or other generally horizontally oriented structure of the vehicle, trailer, or equipment carried by the vehicle or trailer. In other embodiments, the ladder system 900 may be mounted to a vertically oriented structure and/or surface, or a structure or surface that is arranged at an angle between horizontal and vertical. As shown in FIG. 9, the cross-beam system 905 may rest entirely below a roof rack system 105. This arrangement may enable a user to store the ladder system 900 beneath cargo or cargo units attached to the roof rack system 105.

The ladder 915 is shown in an engaged position wherein the ladder 915 is accessible to climb and extends to, and rests upon, a support surface 910. The ladder 915 may enable a person to climb up rungs 920 to a desired height to reach cargo that may be stored atop the roof 110. The rungs 920 may allow a person to load cargo or remove cargo from the roof 110, to clean the roof, or otherwise provide an added height to enable a person to perform a desired function. A total length L of the ladder 915 and number of rungs 920 may be variable. For example, the ladder 915 may expand to differing lengths to accommodate variable vehicle heights and/or variations in support surfaces 910. The ladder 915 may additionally be a telescoping ladder and may have the ability to add and/or remove sections to provide a variable length L. In other embodiments, the ladder 915 may have a fixed number of sections for an overall fixed length L.

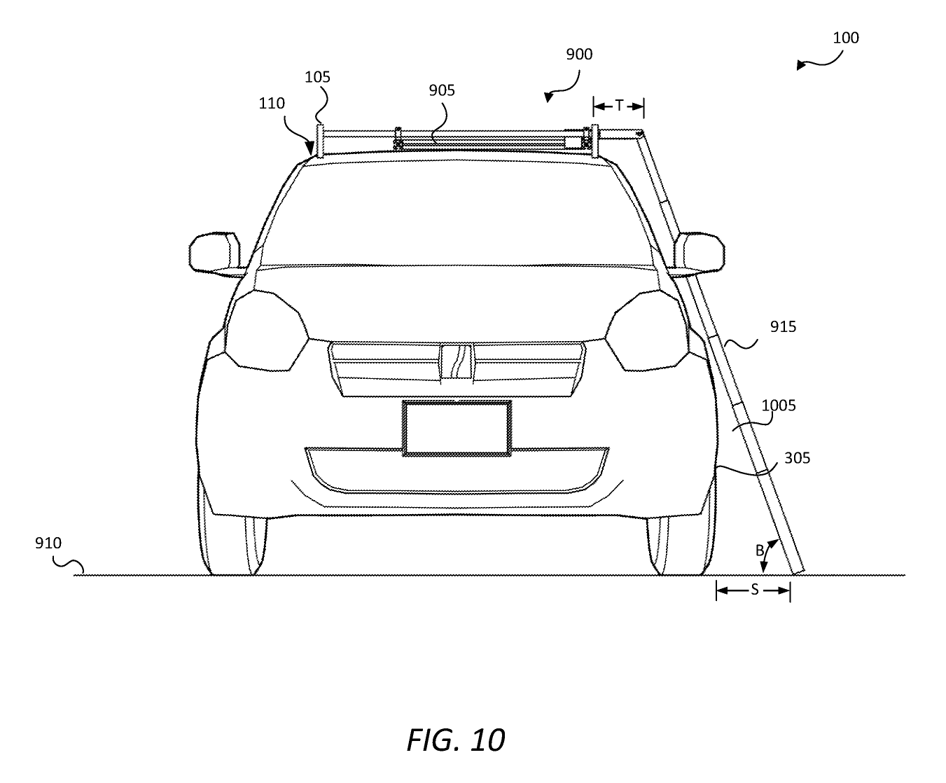

FIG. 10 shows a front view of a vehicle 100 with a roof rack system 105 and ladder system 900 installed proximate the roof 110 of the vehicle. FIG. 10 shows a gap 300 between the ladder 225 and the vehicle 100 wherein the ladder 915 is substantially aligned with a side 305 of the vehicle 100.

Similar to the ladder 225, the ladder 915 may have two adjustable distances which may affect a gap 1005 between the vehicle 100 and the ladder 915. The first adjustable distance may be distance T. Distance T may be the distance the cross-beam system 905 is engaged with the roof rack system 105. The distance T may be negligible, or essentially zero. The distance T may also be expanded to create a more vertical angle B between the ground and the ladder 915. The vertical angle B may be a factor of the distance S and the distance T. If distance T remains constant, the vertical angle A will begin to reach ninety (90) degrees as the distance S is increased. Conversely, if the distance S is constant but the distance T is reduced, the vertical angle B will tend towards zero (0) degrees as the angle B is reduced. The ability to adjust the angle B of the ladder 915 may affect the sturdiness of the ladder 915. Adjusting the angle B may also adjust the gap 1005 between the ladder 915 and the vehicle 100. In some instances, the distance S may be limited due to space surrounding the vehicle 100. For example, in a parking lot, a second vehicle may restrict movement on the side of the vehicle 100. Adjusting the distances S, T may also allow a person to safely engage the ladder 915, find sturdy ground, or comfortably adjust the ladder 915.

The ladder 915 as shown in FIG. 10 has a straight side profile. While a straight curvature is shown, the ladder may have a side profile with a curvature similar to ladder 225 described with reference to FIG. 3.

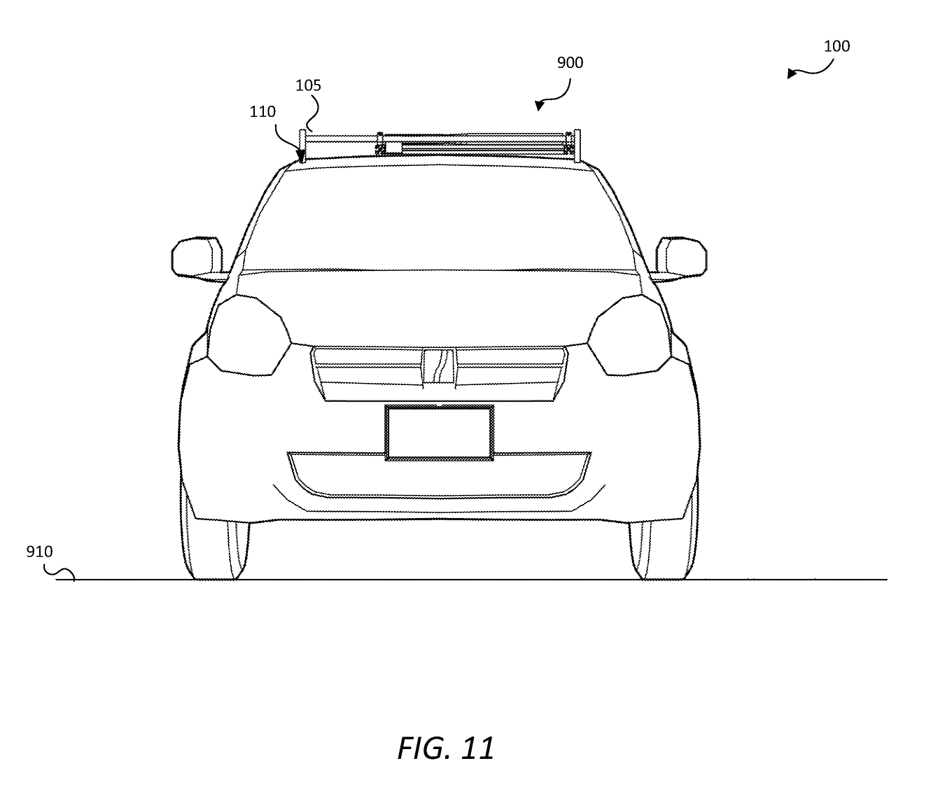

FIG. 11 is a front view of the vehicle 100 with a roof rack system 105 and ladder system 900 installed proximate the roof 110 of the vehicle. The ladder 915 is showed in a collapsed, stored position. The collapsed, stored position of the ladder 915 may allow a user of the automobile to easily transport the ladder with the vehicle 100.

To store the ladder 915, the length L of the ladder 915 may need to be reduced. As mentioned, the ladder 915 may fold onto itself to reduce its length L or it may telescope into itself to a reduced length L. For example, portions of the ladder 915 may store inside other portions of the ladder 915 such that the design is a telescoping design. The ladder 915 may lock and/or maintain an extended position and a telescoped position. The telescoped position may alternatively be an unfolded portion of the ladder 915. The ladder 915 may additionally adjust the length L of the ladder by unfolding sections of the ladder to extend and/or reduce the over length L. The length L of the ladder 915 during storage should be small enough to easily store on the roof 110 of the vehicle 100 or out of the way of a scaffolding or other system attached to a vehicle or trailer. The storage length L of the ladder 915 may be approximately 10-20 percent of the extended length of the ladder 915. The length L of the ladder 915 may vary depending on vehicle make and model. For example, a larger vehicle may require a longer length L of the ladder 915 whereas a smaller vehicle may not have the need for a longer or similar length and therefore may have a shorter or different length L.

The ladder 915 may be rotatably coupled to the cross-beam system. For example, the ladder 915 may be coupled to an axle (e.g. axle 1225, 1225-a, FIG. 12) which may rotate about a portion of the cross-beam system 905. The axle may enable the ladder 915 to move from an engaged or deployed position as shown in FIG. 10 to a stored or stowed position as shown in FIG. 11. The ladder 915 may lock in the stored position which may approximately align with the roof 110 of the vehicle 100 as shown. The ladder 915 may rest on a supporting member proximate the cross-beam system 905 which may prevent the 915 from contacting the roof 110 of the vehicle 100.

In other embodiments, the ladder 915 may be stored at an angle. The angle may also be any angle that may enable the ladder 915 to be stored away from the one or more sides 305 of the vehicle 100. The varying degree of locking angle may enable the ladder 915 to accommodate various sizes and locations of cargo which may be stored proximate the roof 110 of the vehicle 100. For example, when snow equipment such as skis or a snowboard are mounted to the roof rack system 105, the ladder 915 to be stored at a very small angle relative to the roof 110, such as ten to twenty (10-20) degrees. In contrast, when a bicycle or canoe is mounted to the roof rack system 105, the ladder 915 to be stored at a larger angle, such as a forty-five (45) degree angle.

In some embodiments, in a stored configuration, the ladder 915 may rest on a cushioning surface (e.g. cushioning surface 400, FIG. 4) attached to the ladder 915 which may minimize potential stress to the collar device (e.g. collar device described with reference to FIG. 4) and which may protect the roof 110 of the vehicle 100. The cushioning surface may comprise a semi-compressible material and may rest on the roof 110 of the vehicle 100 when the ladder 915 is stored on top of the roof 110. The cushioning surface 400 may comprise a weather-resistant material such as a polymer.

FIG. 12 is a close-up view of the cross-beam system 905. The cross-beam system 905 may attach to a roof rack system (e.g. roof rack system 105) or may attach to other rack systems or structures that may accompany a vehicle. The cross-beam system 905 as shown may include a portion of the ladder 915 and elements of the cross-beam system 905. The ladder 915 may be mounted on either the driver or passenger side of the vehicle 100. In some embodiments, a single vehicle may additionally be fitted with a ladder system on both the driver and passenger side of the vehicle 100. In still further embodiments, the ladder 915 may be movable from the one side of the vehicle to the other (e.g. from the passenger side to the driver side or vice versa).

The cross-beam system 905 may comprise a first brace beam 1205 and a second brace beam 1210. The brace beams 1205, 1210 may support the ladder 915 and be configured to couple the ladder 915 to a rack system. In some embodiments, the brace beams 1205, 1210 may attach directly to a roof rack system (e.g. roof rack system 105) or may attach to other scaffolding or other parts of a vehicle. In other instances, the brace beams 1205, 1210 may attach directly to the vehicle. In other embodiments, as shown in FIG. 12, the brace beams 1205, 1210 may be configured to couple to cross-beams 1215, 1220. The brace beams 1205, 1210 may be rigidly coupled to the cross-beams 1215, 1220 or may be movably mounted to the cross-beams 1215, 1220. For example, the brace beams 1205, 1210 may slide forward and aft on the cross-beams 1215, 1220 as indicated by arrow Z. The forward and aft movement may enable a user to move the ladder 915 to a desired location along a vehicle.

As mentioned, the brace beams 1205, 1210 and/or the cross-beams 1215, 1220 may be configured to couple to a vehicle. The beams 1205, 1210, 1215, 1220 may couple to factory installed roof racks on the vehicle, to aftermarket roof racks on the vehicle, directly to the vehicle, to scaffolding on a vehicle, to a trailer, and the like. The beams 1205, 1210, 1215, 1220 may be compression fit to the vehicle, they may be bolted, adhered, screwed, tied, fastened, or otherwise coupled to the vehicle. In some embodiments U-bolts may be used to secure some or all of the beams 1205, 1210, 1215, 1220 to the vehicle and/or rack, scaffolding, or the like carried by the vehicle. C-clamps may be used as well.

In some embodiments, the beams 1205, 1210, 1215, 1220 may be telescoping for ease of attachment. For example, if the brace beams 1205, 1210 are attached to factory installed roof racks, the brace beams 1205, 1210 may be telescoping to accommodate changes in vehicle width, roof rack geometries, and the like. Similarly, if the brace beams 1205, 1210 are coupled to the cross-beams 1215, 1220, the cross-beams may be telescoping to attach to variances in aftermarket roof rack systems. In some embodiments, all of the beams 1205, 1210, 1215, 1220 may be telescoping. For example, the brace beams 1205, 1210 may adjust in length to accommodate different widths of vehicles and/or trailers to allow ease of installation of the cross-beams 1215, 1220, which also may adjust in length. In some instances, the adjustable length may incorporate a telescoping.

The ladder 915 may be coupled to the brace beams 1205, 1210 via an axle 1225. The ladder 915 may be coupled to a single axle that connects the slideable members 1230, 1235. In other embodiments, the axle 1225 may be a two part axle 1225, 1225-a as shown. The axle 1225 may enable the ladder 915 to rotate from a stored position (discussed with reference to FIG. 11) to an engaged position, as shown in FIG. 9 or 10. For example, the ladder 915 may rotate about axis 1240 as shown by arrow M. The axle 1225 may be rigidly coupled to the ladder 915 and the entire system (e.g. the axle 1225 and the ladder 915) may rotate between the various positions. In another embodiment, the axle 1225 may be stationary and the ladder 915 may be pivotally coupled to the axle 1225.

The ladder 915 may be pivotally coupled to the brace beams 1210, 1215 as discussed above. In some embodiments, the ladder 915 may additionally and/or alternatively be slidably coupled to the brace beams 1210, 1215. For example, the ladder 915 may be pivotally coupled to a first slidable member 1230 and a second slidable member 1235. The first and second slidable members 1230, 1235 may be movably coupled to the first and second brace beams 1205, 1210. For example, the first and second slidable members 1230, 1235 may move along the brace beams 1205, 1210 as indicated by arrow Y. The slidable members 1230, 1235 may be confined to movement within a boundary defined by the brace beams 1205, 1210 and the cross-beams 1215, 1220. In another embodiment, the slidable members 1230, 1235 may extend beyond the boundary aforementioned. For example, the slidable members 1230, 1235 may extend beyond the brace beams 1215, 1220. This may facilitate distance T as discussed with reference to FIG. 10.

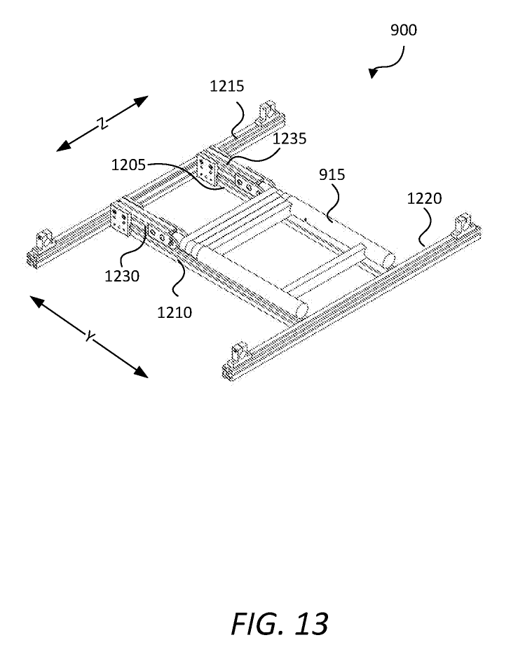

In some embodiments, the slidable members 1230, 1235 may be additionally pivotally attached to the brace beams 1205, 1210. For example, the slidable members 1230, 1235 may pivot to allow the ladder 915 to be deployed on a driver side of the vehicle and a passenger side of the vehicle. The slidable members 1230, 1235 may additionally enable better storage of the ladder 915 as discussed with reference FIG. 13.

When the ladder 915 is deployed as shown, a bushing (not shown) may be proximate at least one of the slidable members 1230, 1235 which may maintain a position of the slidable members 1230, 1235 in relation to the brace beams 1205, 1210. For example, as a user climbs the ladder 915 or otherwise provides a downward force on the ladder 915, the bushing may deform and create a locking mechanism between the slidable member 1230 and the brace beam 1210. The bushing may be coupled to the slidable member 1230 on an underside of the slidable member 1230 proximate the brace bream 1205. The bushing may be positioned such that when the ladder 915 is deployed, it is position between either the slidable member 1230 and the brace beam 1205 and/or the slidable member 1230 and the cross-beam 1220. The bushing may comprise a deforming material such as a polymer or rubber. The bushing may deform when compressed. As the compression occurs, the bushing may maintain a position of the ladder 915.

In some embodiments, the cross-beam system 905 may include a support member 1240. The support member 1240 may span from the first cross-beam 1205 to the second cross-beam 1210. The support member 1240 may be fastened, adhered, or otherwise attached to the first and second cross-beams 1205, 1210. The support member 1240 may prevent the ladder 915 from resting upon the vehicle when in a stored position. The support member 1240 may be substantially planar.

In some embodiments, the ladder 915 may be pivotally movable between a driver side and/or passenger side of a vehicle. The slidable members 1230, 1235 may additionally be able to pivotable. For example, in some instances, the ladder 915 and slidable members 1230, 1235 may rotate about axis 1245 as shown by arrow N. The attachment of the slideable members 1230, 1235 to the brace beams 1205, 1210 may enable the slidable members 1230, 1235 to pivot 180 degrees such that the ladder 915, which may be proximate the cross-beam 1220, may now be proximate the cross-beam 1215. The pivotable motion may enable a person to utilize the ladder 915 on either side of a vehicle and may prevent a user from detaching the ladder system 905 as a whole and reattached the system 905 to function as desired.

FIG. 13 is a close-up view of the cross-beam system 905 with the ladder 915 in a stored position. As shown in the figure, the slidable members 1230, 1235 may fit entirely within a boundary provided by the beams 1205, 1210, 1215, 1220. The ladder 915 may rest upon the support member 1240. In some instances, the ladder 915 may secure to the support member 1240 in this position. The ladder 915 and support member 1240 may include a locking mechanism. In some embodiments, the locking mechanism may include a magnetized system. The ladder 915 may additional rest upon the support member 1240 and gravity may maintain the ladder 915 in this position.

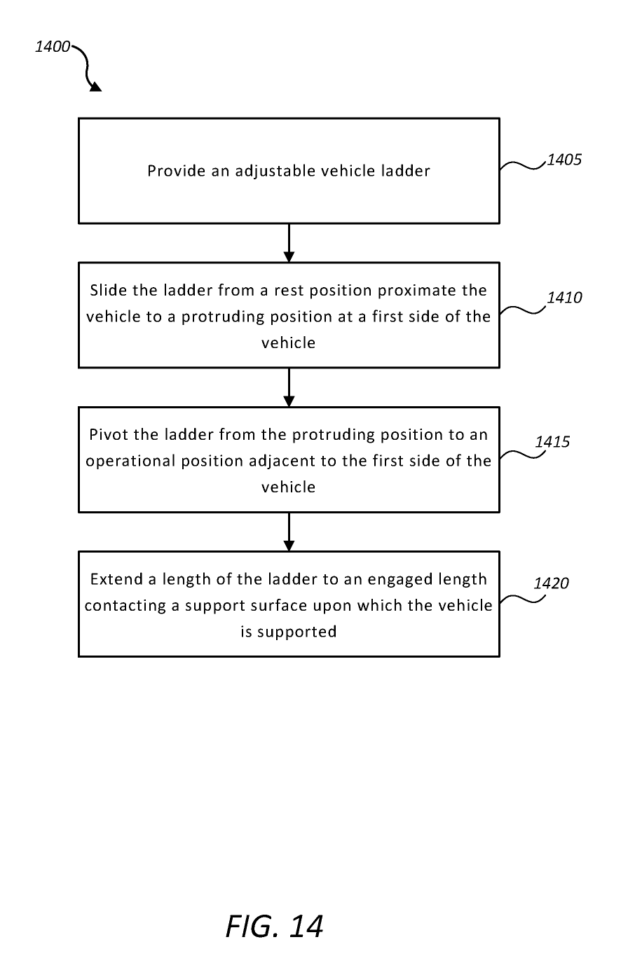

FIG. 14 is an exemplary flow chart of a method 1400 relating to a stowable ladder system, such as a method of operating the ladder system 900 described with reference to FIGS. 9-13. For clarity, the method 1400 is described below with reference to aspects of one or more of the ladder systems 200, 900 shown in FIGS. 2-13.

At block 1405, the method may include providing an adjustable vehicle ladder. The adjustable vehicle ladder may be coupled to the vehicle. The ladder may attach to the roof of a vehicle or another elevated area of the vehicle. The ladder may additionally and/or alternatively be coupled to a trailer or scaffolding system on a vehicle. The ladder may be secured in a rest position. Securing the ladder in the rest position may include using a locking mechanism to maintain the ladder in the rest position.

At block 1410, the method may include sliding the ladder from a rest position proximate the vehicle to a protruding position at a first side of the vehicle. The ladder may slide along slidable members which may enable the ladder to move from the rest position to the first side of the vehicle. Prior to sliding the ladder, the ladder may need to be unsecured from the resting position. This may include unlocking, disconnecting or otherwise unsecuring the ladder from the rest position.

At block 1415, the method may include pivoting the ladder from the protruding position to an operational position adjacent to the first side of the vehicle. At block 1420, the method may include extending a length of the ladder to an engaged length contacting a support surface upon which the vehicle is supported. The ladder may then be fastening in the operational position. The fastening may include an active lock mechanism that a user must engage to operate. The fastening may include a passive fastening that occurs when the ladder is in use. The ladder may additionally be secured to an engaged length. This may include securing individual telescoping sections of the ladder. Telescoping sections of the ladder may enable the ladder system to be transferred from one vehicle to another vehicle. The telescoping sections of the ladder may additionally enable a user to utilize the ladder on varying ground surfaces or to provide varying stability of the ladder when in operation.

In some embodiments, the ladder may be pivoted from the first side of the vehicle to a second side of the vehicle. This may enable a user to access an elevated area of the vehicle from either side or to access multiple areas of the vehicle as necessary. In other embodiments, multiple ladders may be provided to enable a user to access multiple areas of the vehicle.

This description, for purposes of explanation, has been described with reference to specific embodiments. The illustrative discussions above, however, are not intended to be exhaustive or limit the present systems and methods to the precise forms discussed. Many modifications and variations are possible in view of the above teachings. The embodiments were chosen and described in order to explain the principles of the present systems and methods and their practical applications, to enable others skilled in the art to utilize the present systems, apparatus, and methods and various embodiments with various modifications as may be suited to the particular use contemplated.

What is claimed is:

1. An apparatus for accessing an elevated area of a vehicle, the apparatus comprising:
a first brace beam configured to be coupled to the vehicle;
a second brace beam spaced from the first brace beam and configured to be coupled to the vehicle; and
a ladder pivotally coupled to the first and second brace beams, the ladder being movable between a stored position and a deployed position.

2. The apparatus of claim 1, wherein the first and second brace beam are coupled to a rack system proximate the vehicle.

3. The apparatus of claim 1, wherein the vehicle is a trailer.

4. The apparatus of claim 1, wherein the ladder is an adjustable ladder comprising a plurality of sections.

5. The apparatus of claim 4, wherein the ladder further comprises a locking mechanism, and the sections are secured by operation of the locking mechanism to maintain a length of the ladder.

6. The apparatus of claim 5, wherein the length of the ladder is fixed.

7. The apparatus of claim 4, wherein a total number of the plurality of sections determines a length of the ladder when the ladder is fully expanded.

8. The apparatus of claim 1, further comprising:
a first slidable member movably coupled to the first brace beam; and
a second slidable member movably coupled to the second brace beam.

9. The apparatus of claim 8, wherein
the ladder is pivotally coupled to the first slidable member; and
the ladder is pivotally coupled to the second slidable member.

10. The apparatus of claim 9, wherein the first and second slidable members move in line with the first and second brace beam.

11. The apparatus of claim 1, wherein the ladder is movable between a first position in which the ladder is stored on the elevated area of the vehicle, and a second position in which the ladder is accessible for a user to access the elevated area of the vehicle.

12. An apparatus for accessing an elevated area of a vehicle, the apparatus comprising:
a first brace beam having a first end and a second end arranged opposite the first end, the first end being coupled to the first cross-beam and the second end being coupled to the second cross-beam;
a second brace beam having a first end and a second end arranged opposite the first end, the first end being coupled to the first cross-beam and the second end being coupled to the second cross-beam;
a first slidable member movably coupled to the first brace beam;
a second slidable member movably coupled to the second brace beam;
a ladder pivotally coupled to the first and second slidable members, the ladder comprising a plurality of sections and being movable between a stored position and a deployed position.

13. The apparatus of claim 12, further comprising:
a first cross-beam; and
a second cross-beam, the second cross-beam being spaced laterally from the first cross-beam.

14. The apparatus of claim 13, further comprising:
the first brace beam having a first end and a second end arranged opposite the first end, the first end being coupled to the first cross-beam and the second end being coupled to the second cross-beam; and
the second brace beam having a first end and a second end arranged opposite the first end, the first end being coupled to the first cross-beam and the second end being coupled to the second cross-beam.

15. The apparatus of claim 14, further comprising:
the first brace beam being moveably coupled to the first and second cross-beam; and
the second brace beam being moveably coupled to the first and second cross-beam.

16. The apparatus of claim 14, further comprising:
the first brace beam being rigidly coupled to the first and second cross-beam; and
the second brace beam being rigidly coupled to the first and second cross-beam.

17. The apparatus of claim 12, wherein the sections of the ladder determine a total length of the ladder.

18. The apparatus of claim 17, wherein the sections secure a length of the ladder when one or more locking mechanisms are engaged.

19. The apparatus of claim 12, further comprising:
an axle with a first end and a second, the first end being rotatably coupled to the first slidable member and the second end being rotatably coupled to the second slidable member.

20. The apparatus of claim 12, wherein the ladder is pivotable between a first position in which the ladder is stored on the elevated area of the vehicle and a second position in which the ladder is accessible for a user to access the elevated area from a first side of the vehicle.

21. The apparatus of claim 20, wherein the ladder is slidable between the first position and the second position.

22. The apparatus of claim 20, wherein the first slidable member is rotatably coupled to the first brace beam, and the second slidable member is rotatably coupled to the second brace beam.

23. The apparatus of claim 22, wherein the ladder is pivotable into a third position in which the ladders is accessible for a user to access the elevated area from a second side of the vehicle, the ladder being pivotable between the second and third positions upon rotation of the first and second slidable members relative to the first and second brace beams, respectively.

24. The apparatus of claim 20, further comprising:
a support member connecting the first brace beam and the second brace beam, wherein the ladder rests upon the support member in the first position.

25. The apparatus of claim 12, further comprising:
a bushing positioned between the first slidable member and the first cross-beam when the ladder is arranged to permit a user to access the elevated area of the vehicle;
wherein the ladder deforms the bushing between the first slidable member and the first cross-beam upon application of a downward force on the ladder.

26. The apparatus of claim 12, wherein the first and second brace beams are arranged substantially perpendicular to the first and second cross-beams, and the first and second brace beams slidably traverse the first and second cross-beams upon application of a force to the first and second brace beams.

27. The apparatus of claim 12, further comprising:
a first mounting mechanism configured to couple the first brace beam to a vehicle cargo apparatus system; and
a second mounting mechanism configured to couple the second cross-beam to the vehicle cargo apparatus system.

28. A method for accessing an elevated area of a vehicle, the method comprising:
providing an adjustable vehicle ladder;
sliding the ladder from a rest position proximate the vehicle to a protruding position at a first side of the vehicle;
pivoting the ladder from the protruding position to an operational position adjacent to the first side of the vehicle;
extending a length of the ladder to an engaged length contacting a support surface upon which the vehicle is supported.

29. The method of claim 28, further comprising:
unsecuring the ladder from the rest position; and
fastening the ladder in the operational position.

30. The method of claim 28, further comprising:
securing the ladder in the engaged length.

31. The method of claim 28, further comprising:
pivoting the ladder from the first side of the vehicle to a second side of the vehicle.
